(19) United States
(12) Patent Application Publication
(10) Pub. No.: US 2001/0052939 A1
(43) Pub. Date: Dec. 20, 2001

(54) Image recorder and image recording method, in particular for recording objects or scenes in three dimensions

(76) Inventor: Helmut Riedel, Fuerstenfeldbruck (DE)

Correspondence Address: FASSE PATENT ATTORNEYS, P.A., P.O. BOX 726, HAMPDEN, ME, 04444-0726, US

(21) Appl. No.: 09/852,302

(22) Filed: May 9, 2001

(30) Foreign Application Priority Data
May 9, 2000 (DE) 100 22 454.7

(51) Int. Cl. H04N 5/335; H04N 3/14

(52) U.S. Cl. 348/294; 348/301

(57) ABSTRACT

An image recorder for recording objects or scenes in three dimensions comprising a detector unit with a multiplicity of photosensitive pixel elements. This is used to generate signals which contain information, such as brightness and distance for example, about individual image points. A signal output serves to output the image information. The arrangement of the pixel elements contributing to the image information is adapted or can be adapted to expected positions of characteristic image elements, or is irregular. The pixel elements may be permanently installed, or individual pixel elements from an array of pixel elements may be activated or deactivated by programming in order to form, for example, a V-shaped region of interest with regard to the image to be recorded.

### BACKGROUND

1. Field of the Invention

The present invention relates to an image recorder with a detector unit comprising a multiplicity of photosensitive pixel elements for generating signals containing information about individual image points, and a signal output for outputting image information to which the signals of the pixel elements are fed. The invention furthermore relates to an image recording method in which signals containing information about individual image points are generated by means of photosensitive pixel elements, and the signals are then made available as image information. The image recorder and the image recording method are particularly suitable for recording objects or scenes in three dimensions.

2. Description of the Related Technology

Image recorders with a multiplicity of photodetectors are used in many fields of technology, for example in remote detection, for monitoring rooms and in the consumer goods industry. Three-dimensional measuring systems which are suitable for recording 3D range images serve, for example, for optically detecting the shape of objects or surfaces, whereby information about the distance of individual image points is also contained in the recorded image.

An area of application of great practical importance is the fast detection of the 3D shape of any surfaces at distances ranging from 20 cm to 50 meters. High speed recording and processing of image information is particularly necessary for navigation, motion control and the fast 3D surveying of large contours.

Known approaches to recording three-dimensional range images are, for example, radar and laser radar systems. However, they are complex to manufacture and incur high costs. Another possibility is offered by silicon image recorders, which are used in a range image camera. This admittedly achieves a high image resolution according to VGA standard with, for example, 640×480 pixels, however the analysis of the recorded scenes requires considerable time, even with high computing performances.

Photonic mixer devices (PMD) are known as alternative silicon image sensors for 3D range images. Such photonic mixer devices or photonic mixer detectors are described in DE 197 04 496 A1. A pixel of a photonic mixer element has at least two light-sensitive modulation photogates and assigned accumulation gates in order to record the phase and/or amplitude information of an electromagnetic wave. Gate voltages are applied to the modulation photogates, whereas a direct voltage is applied to the accumulation gates, whereby the charge carriers which are generated by an incident electromagnetic wave in the spatial charging zone of the modulation photogate are exposed to the potential gradient of a drift field, as a function of the polarity of the gate voltages, and drift to the corresponding accumulation gate.

R. Schwarte et. al. also described photonic mixer detectors or PMDs during a lecture entitled “Fast and simple optical shape detection with a new type of correlation photodetector array” to the DGZfP-GMA Technical Meeting in Langen on Apr. 28/29, 1997. In the associated lecture paper, among other items, a 1D PMD laser radar with a PMD pixel is shown, in which the distance of a target point in a 3D scene is determined via a phase evaluation of an electromagnetic wave and/or via the phase runtime.

Nevertheless, the problem with the known devices and methods for three-dimensional image recording is that a very great computation effort is required, as well as expensive electronics, particularly for recording a complex scene. This impairs the fast acquisition of information because of the time required. Fast three-dimensional pattern recognition is not possible or only possible with severe limitations, or with a disproportionate effort and high costs.

### SUMMARY OF THE INVENTION

The object of the present invention is to provide an image recorder and an image recording method with which complex scenes can be recorded, even in three dimensions, with increased speed without incurring high expenditure.

According to the first aspect of the present invention, this object is achieved such that the pixel elements contributing to the image information are arranged irregularly, and/or their arrangement is adapted or can be adapted to the expected positions of characteristic image elements. According to the second aspect of the present invention, this object is achieved such that the signals made available correspond to image points, the arrangement of which is adapted to the expected positions of characteristic image elements, and/or the image points are arranged irregularly.

The image recorder according to the invention is particularly suitable for recording objects or scenes in three dimensions, and comprises a detector unit which has a multiplicity of photosensitive pixel elements for generating signals containing information about individual image points, and a signal output, to which the signals of the pixel elements are fed, for outputting the image information, whereby the pixel elements contributing to the image information are arranged irregularly, and/or their arrangement is adapted or is adaptable to the expected positions of characteristic image elements.

The image recorder according to the invention or 3-D image sensor enables a high processing speed and in particular fast recognition of 3D patterns to be achieved. Particularly cost-effective 3D image sensors can be produced by using a minimized pixel count which is, for example, restricted to a defined arrangement. The pixel arrangement is thus, for example, adapted to a scene which is to be recorded so that the image of the characteristic features of the scene can be recorded with just a few pixels.

It is advantageous if the pixel elements can be addressed directly. The pixel elements can also be addressed sequentially or optionally. In the case where the individual pixels are addressed sequentially, e.g. via a shift register, the entire image information can be made available as a sequential data stream.

The addressing of the pixel elements is, for example, discretionary or it may be made in a predefined sequence.

For example, the pixel elements contributing to the image information may be arranged in a V or cruciform shape. However, they may also be arranged in a line, for example with irregular spacings between each other. In particular, in this way a higher pixel density can be provided in so-called regions of interest (ROI) than in less interesting areas.

It is advantageous if the pixel elements are programmable so that, from a multiplicity of pixel elements, selected pixel elements may be activated and/or deactivated. In this case, the detector not only contains a smaller number of pixel elements, but also only specific pixel elements in a line or line arrangement are activated in order to record the essential image information. The image processing speed is increased by dispensing with the recording and processing of unimportant image information.

Preferably, programmable elements are provided for selecting the pixel elements. Advantageously, suitable switches are used to bridge individual pixels and/or to interrupt address lines. For example, EPROM chips may be provided, or even fusible electrical links with which individual pixel elements may be permanently activated or deactivated.

Preferably, the image recorder comprises a line decoder and/or a column decoder for addressing the programmable elements. In particular, a shift register serves to read out the pixel elements contributing to the image information or selected pixel elements.

Preferably, one or a plurality of video lines are provided which serve to output the signals of the pixel elements. In the image recorder according to the invention, there are advantageously photonic mixer devices or photonic mixer detectors with which three-dimensional range images can be recorded.

In the image recording method according to the invention, in particular for recording objects or scenes in three dimensions, by means of photosensitive pixel elements, signals are generated containing information about individual image points, and these signals are then made available as image information, whereby the signals made available correspond to image points, the arrangement of which is adapted to the expected positions of characteristic image elements, or the image points are arranged irregularly. Processing speeds can be increased with the method, so that measuring tasks under known scene conditions can be fulfilled with a minimum number of detector elements. The image processing tasks are thus made considerably easier. In particular, the pixels are adapted to the expected scene and/or to the image processing algorithms used.

Permanently arranging a reduced number of pixel elements, for example irregularly or in various geometric shapes, also enables substantial costs to be saved. The quantities of data for further image processing are kept as small as possible. This is done, for example, by using existing knowledge about the scene to be analyzed in order to configure detector blocks optimally.

In the image recording method, the pixel elements are advantageously addressed sequentially or optionally. The sequence in which the pixel elements are addressed may also be specifically selected for the application.

For example, the pixel elements may be addressed by line jump, or meandering line-by-line.

Advantageously, the pixel elements are programmed in order to activate and/or deactivate selected pixel elements. In this manner, pixel elements can, for example, be activated or selected specifically to meet different requirements.

Advantageously, the pixel elements are dynamically reprogrammed during the recording. This makes it possible to adapt to changing scenes during the recording, whereby the data processing speed is nevertheless increased without losing crucial information.

### BRIEF DESCRIPTION OF THE FIGURES

The invention is described in the following with the aid of examples and the figures. They show:

FIG. 1 a PMD detector line with an irregular pixel arrangement as a first preferred embodiment of the invention;

FIG. 2 a PMD detector array with a V-shaped region of interest (ROI) as a further embodiment of the invention;

FIG. 3 a PMD detector array with a cruciform region of interest corresponding to yet another embodiment of the invention;

FIG. 4 a PMD array with optional addressing;

FIG. 5 a PMD array with sequential addressing;

FIG. 6 a PMD detector line with pixel programming corresponding to another preferred embodiment of the invention;

FIG. 7 the architecture of a PMD array with programmable pixels;

FIG. 8 an array read out in the line jump method, and

FIG. 9 an array read out which proceeds meandering line-by-line.

### DESCRIPTION OF THE PREFERRED EMBODIMENTS

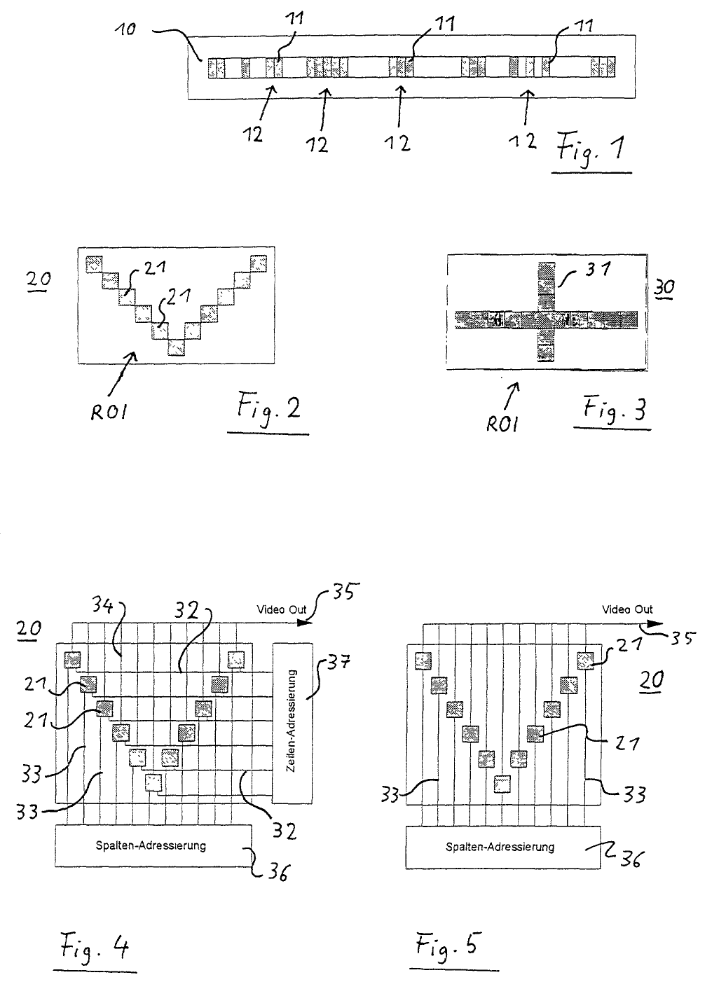

A detector line 10 is shown diagrammatically in FIG. 1. It contains pixel elements 11 and pixels or image recording points which are arranged irregularly. In which some pixel elements lie directly adjacent, whereas there is a physical distance between other pixel elements. The distances between the pixel elements 11 vary in size so that so-called regions of interest 12 are formed which have a higher pixel density than less interesting areas. Whereby the arrangement of the pixel elements 11 with the regions of interest 12 is adapted to the scene which is expected to be recorded by the image recorder.

In the image recorder according to the invention, the arrangement of the pixel elements 11 and the detector line 10 is freely selectable in the focal plane, so that the image recorder is adapted to the measuring task of the measuring system in order to record three-dimensional objects or images or scenes.

The detector line 10 may, for example, be used in production or manufacturing to determine the location of work pieces. With specified locations, the image recording and image processing are restricted to those areas of the image in which work pieces can be found, whereas the other areas do not take up any resources or computing time.

A detector line 20 is shown in FIG. 2. In which all the pixel elements 21 are arranged in a V-shape so that they form a V-shaped region of interest (ROI). The V-shaped preferred lines of the pixel elements 21 as ROI are particularly suitable for pre-crash sensing in vehicle technology. In this case, a V-shaped image section projecting forwards from the vehicle is recorded which is processed at such a high speed that hazardous situations are automatically detected in good time, and appropriate automatic functions such as warning or steering functions can be executed.

FIG. 3 shows a detector arrangement 30 with pixel elements 31 arranged cruciformly. This array arrangement has a horizontal and a vertical line as region of interest or ROI. Such an image recorder is, for example, arranged in a vehicle in order to detect obstacles on streets, preferably with the horizontal line of pixel elements 31. Vertical obstacles, for example limited clearance heights in garage entrances or tunnels, are detected by the vertical line as ROI. Here again, the number and arrangement of the pixel elements 31 is adapted to the measuring task and/or to the expected scene so that obstacles can be quickly detected with cost-effective image recorders. Tracking tasks and tracking measures can also be realized quickly and cost-effectively with the image recorder according to the invention.

The individual pixels or pixel elements 11, 21, 31 are addressed, for example, directly with individual signal outputs.

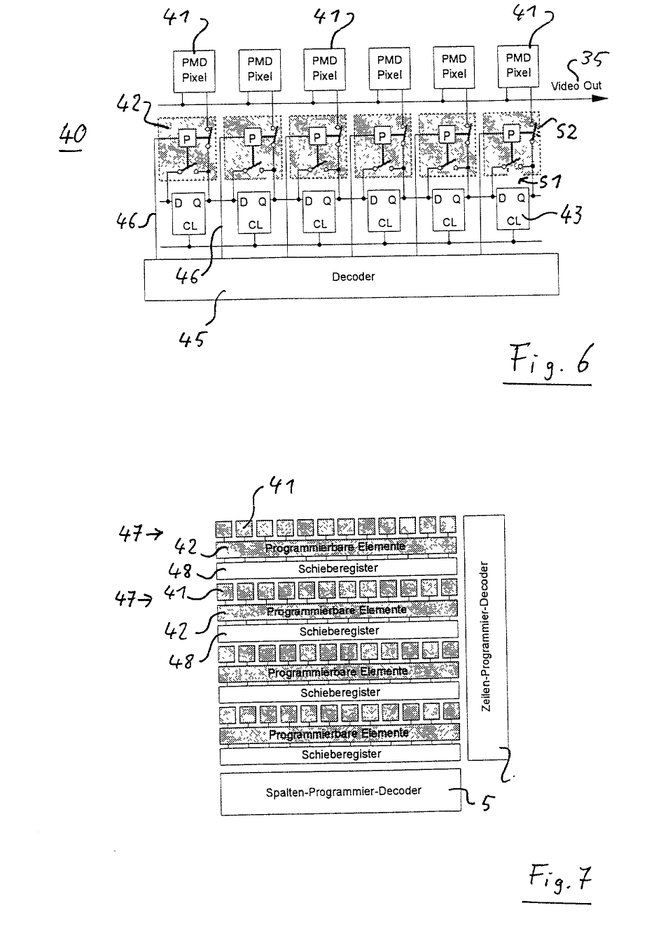

FIG. 4 shows the detector arrangement 20 with V-shaped ROI and optional addressing. The pixel elements 21 are individually or singly controlled by a matrix of horizontal address wires 32 and vertical address wires 33. A pixel element output wire 34 runs from each pixel element 21 to a video signal output 35. A column address unit 36 is linked to the individual pixel elements 21 by the vertical addressing wires 33. A line address unit 37 is linked to the individual pixel elements 21 by the horizontal address wires 32.

In the detector arrangement 20 with a V-shaped ROI shown in FIG. 5, the pixel elements 21 are addressed sequentially with the aid of a shift register. Whereby the sequence of pixels is, for example, specifically defined for the application. Here, only a column addressing unit 36 is provided, which is linked by an address wire 33 to each of the pixel elements 21. In operation, the generated pixel signals are output from the 3D range image recorder on one or a plurality of video lines. The video signal output 35 is shown diagrammatically in the figure.

The pixel elements 11, 21, 31 are photonic mixer devices as described in detail in DE 197 04 496 A1, which was mentioned at the beginning, to the content of which express reference is made here. In respect of the concrete embodiment of the pixel elements 11, 21, 31, reference is made once again to the paper mentioned in association with the lecture referred to at the beginning. The pixel elements 21 of FIG. 4 are addressed by multiplexers.

FIG. 6 shows a detector line 40 with programmable PMD pixel elements 41. A shift register with shift register stages 43 serves as an addressing unit for the individual pixels or pixel elements 41. The flip-flop stages of the shift register can be individually bridged by programmable elements 42, of which one is contained in each pixel element 41, or is assigned or coupled to it.

The programmable elements 42 each contain a switch S1 which in the closed state bridges the associated flip-flop stage or shift register stage 43. The associated pixel, which is assigned to the shift register stage 43, is thus not addressed in this state of switch S1 and is skipped in the serial signal read out.

A further switch S2 in the programmable element 42 makes the contact to the associated pixel element 41. With switch S2 in the open state, the pixel element 41 is thus additionally separated from the shift register stage 43.

The pixel element 41 associated with a programmable element 42 is thus deactivated with switch S1 closed and switch S2 open, and activated with switch S1 open and switch S2 closed. In this manner, any selection of pixels or pixel elements 41 can be made from the entire detector line 40. The programmable element 42 can be addressed in a simple manner via a decoder block.

Such switches can be realized, for example in CMOS technology, with the aid of a few transistors. The switch setting is programmed, i.e. the potentials at the gates of the switch transistors are set, via, for example, EPROM chips, which are also arranged on the image recorder. However, so-called fusible links, which create a permanent switch setting during the programming, may also be used. Both options may be implemented in the programmable elements 42.

When programming the programmable elements 42, one or a plurality of pixel elements 41 are excluded from the addressing, in that, as mentioned above, the input D and the output Q of the shift register stage 43 are bridged by the switch S1. Additionally, the address line leading from the connection Q of the shift register stage 43 to the pixel element 41 is interrupted by the programming via the above-mentioned switch S2.

A decoder unit 45 is linked to each of the programmable elements 42 by address wires 46 so that they can be addressed.

When EEPROM chips are used for realizing the image recorder or detector block, the selection of the pixels or pixel elements 41 can be dynamically changed during detector operation. This enables the image recorder to be dynamically adapted to varying scene conditions.

FIG. 7 shows a two-dimensional array arrangement of pixel elements 41 which can be selected, activated or deactivated by the programmable elements 42. Whereby a horizontal shift register 48 is assigned to each pixel line 47 of the array. A line decoder 50 and a column decoder 51 serve to address the programmable elements 42. After programming, only the selected pixels are read out in a serial data stream to one or a plurality of video lines.

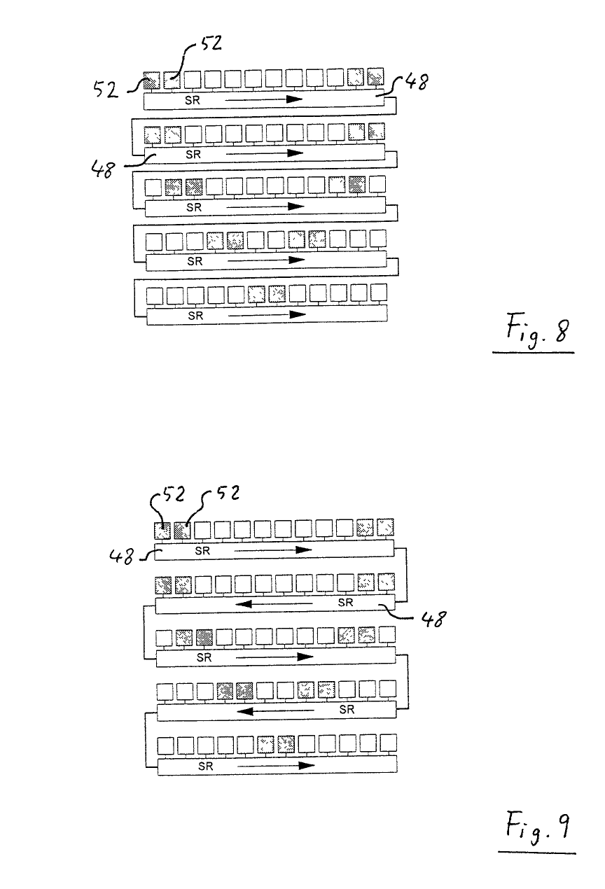

FIG. 8 shows the array read out in the line jump method diagrammatically. In which the read-out always takes place in the same direction. In the array of pixel elements shown here, selected pixel elements 52 are activated by programming to form a V-shaped arrangement of active pixels.

FIG. 9 shows an array read out which proceeds line-by-line in a meandering manner. In which the read-out direction alternates from line to line, so that after running through a shift register 48, the following shift register is run through in the opposite direction. Here again, selected pixel elements 52 are activated according to a preset region of interest ROI.

In FIGS. 8 and 9, the selected pixel elements 52 are depicted with dark shading so that the V-shaped region of interest on the image recorder is recognizable. The number of video lines can be adapted to meet the requirements of the application. As a rule, the video line is implemented as a two-wire system for the differential read out of the PMD signals.

To summarize, the invention creates a 3D range image recorder, preferably according to the PMD principle, in which a detector line or a detector array can be equipped with programmable pixels, and in which the application-specific pixel selection is preferably made by programming and the pixels can be optionally programmed. Furthermore, the pixels can be dynamically reprogrammed during detector operation, and a two-dimensional array of pixel elements can be addressed line-by-line by shift registers. The addressing may take place by line jump or meandering line-by-line, and the detector signals are output from the 3D range image recorder via one or a plurality of video lines.

The detector line or the detector array may have an irregular, application-specific PMD pixel arrangement according to the requirements of the application concerned. The pixels may be addressed sequentially or optionally, whereby with sequential addressing the sequence of the pixels can be selected specifically for the application.

In all, the invention enables 3D range images to be recorded with the aid of a silicon image recorder, in which the positions of the image points in the focal plane are adapted to the positions of characteristic features within the scene to be recorded. In this manner, a complex scene with known features can be analyzed in real-time with a low number of image points. The image recorders required for this are simple and cost-effective. Instead of arranging the pixels in a detector line or detector array regularly and at a high overall density, in the present invention only a low number of pixel elements are provided for recording the characteristic features of the scene, in which the few pixel elements are either permanently arranged or, from a large number of pixels, individual pixels can be activated or deactivated by appropriate programming. A particularly fast sequential image read-out process takes place by means of shift registers. Dynamic reprogramming of the pixels during detector operation enables flexible selection of the pixels. Above all, the invention enables fast 3D pattern recognition by means of a pixel arrangement adapted to the scene.

With the range image recorder according to the invention, the head positions of the occupants of automotive vehicles can, for example, be determined in order to individually adapt the quantity of gas to be emitted into an airbag to the head position, and so reduce the risk of injury. It is also possible to have an out-of-position sensor system in which a camera monitors the driver and passenger to determine their positions.

A further possible application is the pre-crash sensor system, in which the range image recorder very quickly automatically detects whether persons or objects are in the vicinity of the vehicle in order to then intervene in the vehicle functions, for example, by braking or triggering a warning function.

The range image recorder according to the invention and the method for obstacle detection are particularly suitable, for example, in stop and go traffic in which the preceding vehicle is monitored and braking is initiated upon reaching a minimum distance which is, for example, a function of the prevailing driving state.

The present invention may also be part of an interior monitoring system, for example, in order to detect a change of state in the vehicle and trigger an alarm. In this way, the interior of the vehicle can be monitored in a cost-effective manner with only a few image elements, in particular for safeguarding against theft. Furthermore, many different applications are possible, for example in automation, manufacturing technology and in other areas.

What is claimed is:

1. Image recorder, in particular for recording objects or scenes in three dimensions, with a detector unit comprising a multiplicity of photosensitive pixel elements for generating signals containing information about individual image points, and
a signal output to which the signals of the pixel elements are fed for outputting the image information,
wherein
the pixel elements contributing to the image information are arranged irregularly, and/or their arrangement is adapted or is adaptable to the expected positions of characteristic image elements.

2. Image recorder according to claim 1 wherein the pixel elements can be directly addressed.

3. Image recorder according to claim 1 wherein the pixel elements can be sequentially or optionally addressed.

4. Image recorder according to claim 2 wherein the pixel elements contributing to the image information are arranged in a V-shape or cruciform shape.

5. Image recorder according to claim 4 wherein the pixel elements may be programmed in order to activate or deactivate selected pixel elements.

6. Image recorder according to claim 5 wherein there are programmable elements for selecting pixel elements.

7. Image recorder according to claim 6 wherein there are switches for bridging pixels and/or for interrupting address lines.

8. Image recorder according to claim 7 wherein there are fusible electrical links for permanently activating or deactivating individual pixel elements.

9. Image recorder according to claim 8 wherein there is a line decoder and/or a column decoder for addressing the programmable elements.

10. Image recorder according to claim 9 wherein there is a shift register for reading out pixel elements contributing to the image information or selected pixel elements.

11. Image recorder according to claim 10 wherein there are photonic mixer devices for recording three-dimensional range images.

12. Image recorder according to claim 3 wherein the pixel elements contributing to the image information are arranged in a V-shape or cruciform shape.

13. Image recorder according to claim 12 wherein the pixel elements may be programmed in order to activate or deactivate selected pixel elements.

14. Image recorder according to claim 13 wherein there are programmable elements for selecting pixel elements.

15. Image recorder according to claim 14 wherein there are switches for bridging pixels and/or for interrupting address lines.

16. Image recorder according to claim 15 wherein there are fusible electrical links for permanently activating or deactivating individual pixel elements.

17. Image recorder according to claim 16 wherein there is a line decoder and/or a column decoder for addressing the programmable elements.

18. image recorder according to claim 17 wherein there is a shift register for reading out pixel elements contributing to the image information or selected pixel elements.

19. Image recorder according to claim 18 wherein there are photonic mixer devices for recording three-dimensional range images.

20. Image recording method, in particular for recording objects or scenes in three dimensions, in which signals containing information about individual image points are generated by means of photosensitive pixel elements, and the signals are then made available as image information,
wherein
the signals made available correspond to image points, the arrangement of which is adapted to the expected positions of characteristic image elements, and/or which are arranged irregularly.

21. Image recording method according to claim 20 wherein the pixel elements can be sequentially or optionally addressed.

22. Image recording method according to claim 20 wherein the sequence in which the pixel elements are addressed is selected according to the application.

23. Image recording method according to claim 20 wherein the pixel elements can be addressed by line jump or by meandering line-by-line.

24. Image recording method according to claim 20 wherein the pixel elements are programmed in order to activate and/or deactivate selected pixel elements.

25. image recording method according to claim 24 wherein the pixel elements are dynamically reprogrammed during the recording.
